(19) United States
(12) Patent Application Publication
(10) Pub. No.: US 2024/0028227 A1
(43) Pub. Date: Jan. 25, 2024

(54) SEPARATING SEQUENTIAL I/O WORKLOADS ACCESSING A VOLUME IN AN I/O STREAM OF MULTIPLE SUPERIMPOSED SEQUENTIAL I/O WORKLOADS

(71) Applicant: International Business Machines Corporation, Armonk, NY (US)

(72) Inventors: Georg Basil Richard Dr Moshous, Unterföhring (DE); Adriana Pellegrini Furnielis, Valinhos (BR); Sarvesh S. Patel, Pune (IN); Marc Henri Coq, Hopewell Junction, NY (US); Ebenezer kofi, Duluth, GA (US)

(21) Appl. No.: 17/870,606

(22) Filed: Jul. 21, 2022

(51) Int. Cl. G06F 3/06

(52) U.S. Cl. CPC G06F 3/0635; G06F 3/064; G06F 3/0604; G06F 3/067

(57) ABSTRACT

In one general embodiment, a computer-implemented method includes detecting individual sequential input/output (I/O) workloads in a stream of superimposed I/O workloads accessing a same physical volume. The detecting is based on a time dependency corresponding to accesses of blocks of the volume. In another general embodiment, a computer-implemented method includes detecting a plurality of sequential input/output (I/O) workloads in an I/O stream of superimposed workloads accessing a same volume, the detecting being based on a time dependency corresponding to accesses of blocks of the volume. A sequentiality factor is calculated for each of the sequential I/O workloads.

### BACKGROUND

The present invention relates to managing input/output (I/O) workloads, and more specifically, this invention relates to separating sequential I/O workloads accessing a volume in an I/O stream of multiple superimposed sequential I/O workloads.

Storage systems, such as storage subsystems of larger computing and/or storage systems, improve read I/O latencies using read-caches which are located in high speed memory such as DRAM. The latency of a cache hit in DRAM, for example, is about an order of magnitude lower than cache miss, when the I/O target is not present in the cache and must be passed to the storage backend.

One strategy for enhancing the amount of cache hits is to determine when sequential I/O is happening and to pre-fetch data from the storage backend and put the pre-fetched data into the cache before the next I/O operation requests the data. The storage systems normally keep track of sequential I/Os in the boundaries of individual volumes. Using the SCSI and NVMe protocol, for example, these volumes have individual I/O queues (SCSI: 1 queue, NVMe: 64 k queues).

It is good practice to operate with volumes separated at host level if the workload of the application is known. For example, a relational database system requires database files and redo logs, and placing these logs on individual volumes with disjunct I/O queues greatly increases the performance of the application.

With the explosion of capacity, the consolidation of workloads and the tendency to virtualize Virtual Machines (VMs) and containers, it is now common to have multiple workloads being backed by only one single large volume of the storage system. In such environments, a mixture of all the I/Os of the different applications is consolidated on the I/O queue(s) of the volume. If multiple sequential I/Os of different applications are happening at the same time, the I/O stream on the volume will be pseudo-random if the host is not separating each sequential stream of I/Os into individual I/O queues by itself. A storage system is then not able to detect sequentially in the IO stream without additional processing.

In virtualized and container environments the workloads of multiple virtual machines and/or containers are overlapping at the host bus adapter level, and sequential I/O cannot be detected in the resulting I/O queue by the attached storage systems.

### SUMMARY

A computer-implemented method, in accordance with one embodiment, includes detecting individual sequential input/output (I/O) workloads in a stream of superimposed I/O workloads accessing a same physical volume. The detecting is based on a time dependency corresponding to accesses of blocks of the volume.

A computer-implemented method, in accordance with another embodiment, includes detecting a plurality of sequential input/output (I/O) workloads in an I/O stream of superimposed workloads accessing a same volume, the detecting being based on a time dependency corresponding to accesses of blocks of the volume. A sequentiality factor is calculated for each of the sequential I/O workloads.

A computer program product, in accordance with one embodiment, includes a computer readable storage medium having program instructions embodied therewith. The program instructions are executable by a processor to cause the processor to detect, by the processor, individual sequential input/output (I/O) workloads in a stream of superimposed I/O workloads accessing a same physical volume. The detecting is based on a time dependency corresponding to accesses of blocks of the volume.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a network architecture, in accordance with one embodiment of the present invention.

FIG. 2 is a diagram of a representative hardware environment that may be associated with the servers and/or clients of FIG. 1, in accordance with one embodiment of the present invention.

FIG. 3 is a diagram of a tiered data storage system, in accordance with one embodiment of the present invention.

FIG. 4 is a flowchart of a method for separating sequential input/output (I/O) workloads accessing a volume in an I/O stream of multiple superimposed sequential I/O workloads, in accordance with one embodiment.

FIG. 5 is a flowchart of a method for separating sequential input/output (I/O) workloads accessing a volume in an I/O stream of multiple superimposed sequential I/O workloads, in accordance with one embodiment.

FIG. 6 is a diagram of a system having a storage subsystem being accessed by a host side, in accordance with one embodiment.

FIG. 7 is a diagram of a system having a storage subsystem being accessed by a host side, in accordance with one embodiment.

FIG. 8 depicts a bitmap of a portion of a volume.

FIG. 9 depicts a bitmap of a portion of a volume.

FIG. 10 depicts a bitmap of a portion of a volume, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for separating sequential I/O workloads accessing a volume in an I/O stream of multiple superimposed sequential I/O workloads. In one embodiment, the methodology provided herein delivers a separation of multiple sequential I/O workloads running against the same I/O queue of a storage volume at the storage system controller, and in preferred approaches, without knowledge of the setup in the servers, VMs and/or containers.

In one general embodiment, a computer-implemented method includes detecting individual sequential input/output (I/O) workloads in a stream of superimposed I/O workloads accessing a same physical volume. The detecting is based on a time dependency corresponding to accesses of blocks of the volume.

In another general embodiment, a computer-implemented method includes detecting a plurality of sequential input/output (I/O) workloads in an I/O stream of superimposed workloads accessing a same volume, the detecting being based on a time dependency corresponding to accesses of blocks of the volume. A sequentiality factor is calculated for each of the sequential I/O workloads.

In yet another general embodiment, a computer program product includes a computer readable storage medium having program instructions embodied therewith. The program instructions are executable by a processor to cause the processor to detect, by the processor, individual sequential input/output (I/O) workloads in a stream of superimposed I/O workloads accessing a same physical volume. The detecting is based on a time dependency corresponding to accesses of blocks of the volume.

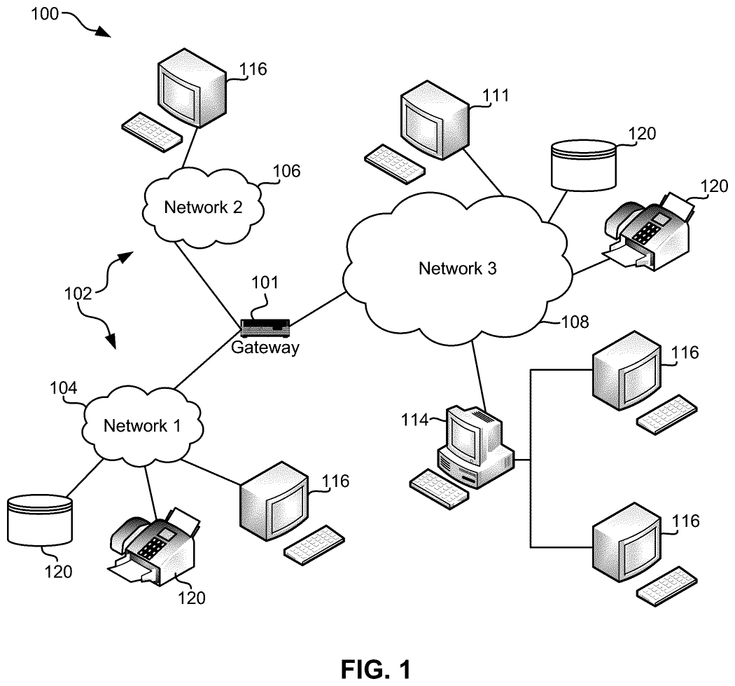

FIG. 1 illustrates an architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present architecture 100, the networks 104, 106 may each take any form including, but not limited to a local area network (LAN), a wide area network (WAN) such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. User devices 116 may also be connected directly through one of the networks 104, 106, 108. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX® system which emulates an IBM® z/OS® environment (IBM and all IBM-based trademarks and logos are trademarks or registered trademarks of International Business Machines Corporation and/or its affiliates), a UNIX® system which virtually hosts a known operating system environment, an operating system which emulates an IBM® z/OS® environment, etc. This virtualization and/or emulation may be enhanced through the use of VMware® software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

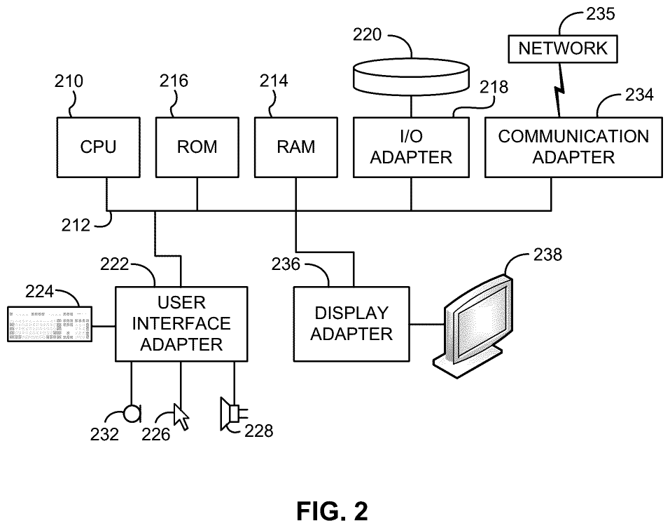

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an input/output (I/O) adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a macOS®, a UNIX® OS, etc. It will be appreciated that a preferred embodiment may also be implemented on platforms and operating systems other than those mentioned. A preferred embodiment may be written using eXtensible Markup Language (XML), C, and/or C++ language, or other programming languages, along with an object oriented programming methodology. Object oriented programming (OOP), which has become increasingly used to develop complex applications, may be used.

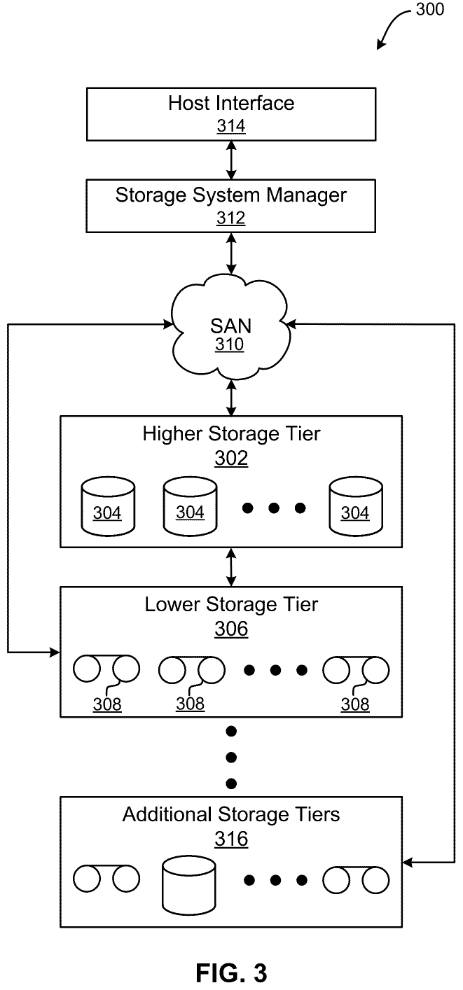

Now referring to FIG. 3, a storage system 300 is shown according to one embodiment. Note that some of the elements shown in FIG. 3 may be implemented as hardware and/or software, according to various embodiments. The storage system 300 may include a storage system manager 312 for communicating with a plurality of media and/or drives on at least one higher storage tier 302 and at least one lower storage tier 306. The higher storage tier(s) 302 preferably may include one or more random access and/or direct access media 304, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 306 may preferably include one or more lower performing storage media 308, including sequential access media such as magnetic tape in tape drives and/or optical media, slower accessing HDDs, slower accessing SSDs, etc., and/or others noted herein or known in the art. One or more additional storage tiers 316 may include any combination of storage memory media as desired by a designer of the system 300. Also, any of the higher storage tiers 302 and/or the lower storage tiers 306 may include some combination of storage devices and/or storage media.

The storage system manager 312 may communicate with the drives and/or storage media 304, 308 on the higher storage tier(s) 302 and lower storage tier(s) 306 through a network 310, such as a storage area network (SAN), as shown in FIG. 3, or some other suitable network type. The storage system manager 312 may also communicate with one or more host systems (not shown) through a host interface 314, which may or may not be a part of the storage system manager 312. The storage system manager 312 and/or any other component of the storage system 300 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 300 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 302, may include a majority of SSD storage media for storing data in a higher performing storage environment, and remaining storage tiers, including lower storage tier 306 and additional storage tiers 316 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 302, while data not having one of these attributes may be stored to the additional storage tiers 316, including lower storage tier 306. Of course, one of skill in the art, upon reading the present descriptions, may devise many other combinations of storage media types to implement into different storage schemes, according to the embodiments presented herein.

According to some embodiments, the storage system (such as 300) may include logic configured to receive a request to open a data set, logic configured to determine if the requested data set is stored to a lower storage tier 306 of a tiered data storage system 300 in multiple associated portions, logic configured to move each associated portion of the requested data set to a higher storage tier 302 of the tiered data storage system 300, and logic configured to assemble the requested data set on the higher storage tier 302 of the tiered data storage system 300 from the associated portions.

Of course, this logic may be implemented as a method on any device and/or system or as a computer program product, according to various embodiments.

Overview of Separating Sequential I/O Workloads In an I/O Stream of Multiple Superimposed Sequential I/O Workloads

The methodology presented hereinbelow enables separation of multiple sequential I/O workloads running against the same I/O queue of a storage volume. The various determinations and computations can be performed at the storage system controller in some approaches, and in some aspects, without knowledge of the setup in the servers, VMs and/or containers. By detecting sequential I/O patterns, various processes described herein are able to optimize (reduce) latency of overlapping workloads.

By introducing a time dependency, the individual sequential I/O patterns in storage environments where many I/Os from different workloads overlap are recognized. The time dependency can be in real time, based on I/O count (e.g., by counting every I/O) in a table or map of accessed blocks, etc.

In further approaches, a sequentiality factor is calculated for some or all of the sequential I/O streams. Based on the sequentiality factor, an optimal cache strategy can be determined. Moreover, further improvements are achievable by considering parameters of the storage system, such as available memory, load on the storage backend, etc. Based on factors such as the achieved performance benefit for the host workload, a user input, etc., the parameters of the optimization can be adjusted on a per volume basis.

In one approach, the knowledge regarding separate sequential I/O workloads and the sequentiality factors are used to optimize the read ahead provided by the storage system and deliver better (lower) latencies for the I/O access. This in turn results in better overall performance to the applications which are driving the individual workloads.

Any of the aforementioned functionality may be activated on a per volume basis. By using these features on a volume basis, additional storage resources such as CPU, memory, and backend I/Os can be allocated to the more critical applications and their storage volumes. Also, the sequentiality factor can be analyzed per volume to get a better understanding of the workload.

Moreover, aspects of the aforementioned functionality may be selectively activated based on predefined parameters, such as the availability of system resources, current and/or historical system performance, etc.

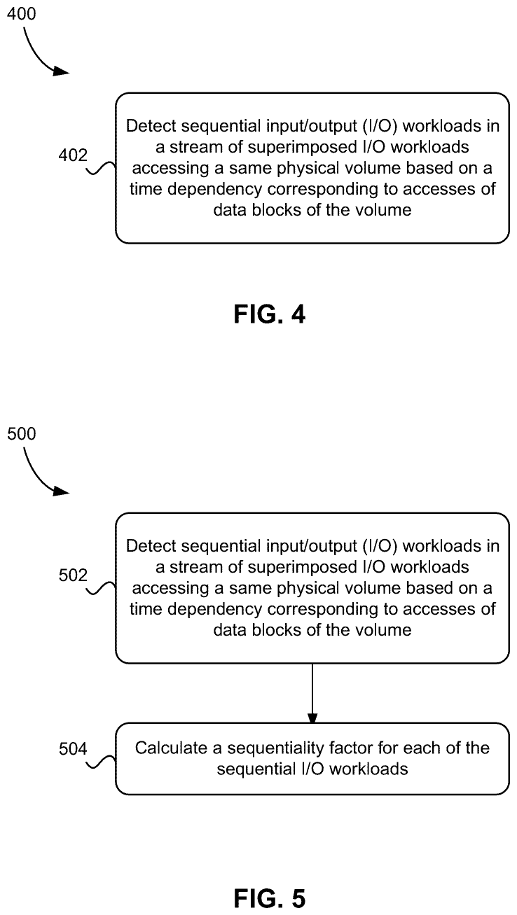

Now referring to FIG. 4, a flowchart of a method 400 for separating sequential input/output (I/O) workloads accessing a volume in an I/O stream of multiple superimposed sequential I/O workloads is shown according to one embodiment. The method 400 may be performed in accordance with the present invention in any of the environments depicted in FIGS. 1-3, among others, in various embodiments. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a storage system (e.g., via its storage controller) having a volume, a controller of a storage subsystem of a larger storage system, or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, method 400 includes operation 402, in which individual sequential input/output (I/O) workloads in a stream of superimposed I/O workloads accessing a same physical volume are detected. The detecting is based on a time dependency corresponding to accesses of data blocks of the volume, as will be elaborated on in detail below. Note that there may be many superimposed I/O workloads, some or all of which are detected as being sequential I/O workloads.

Now referring to FIG. 5, a flowchart of a method 500 for separating sequential input/output (I/O) workloads accessing a volume in an I/O stream of multiple superimposed sequential I/O workloads is shown according to one embodiment. The method 500 may be performed in accordance with the present invention in any of the environments depicted in FIGS. 1-4, among others, in various embodiments. Of course, more or fewer operations than those specifically described in FIG. 5 may be included in method 500, as would be understood by one of skill in the art upon reading the present descriptions.

Each of the steps of the method 500 may be performed by any suitable component of the operating environment. For example, in various embodiments, the method 500 may be partially or entirely performed by a storage system (e.g., via its storage controller), a controller of a storage subsystem of a larger storage system, or some other device having one or more processors therein. The processor, e.g., processing circuit(s), chip(s), and/or module(s) implemented in hardware and/or software, and preferably having at least one hardware component may be utilized in any device to perform one or more steps of the method 500. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 5, method 500 includes operation 502, in which sequential input/output (I/O) workloads in a stream of superimposed I/O workloads accessing a same physical volume are detected. The detecting is based on a time dependency corresponding to accesses of data blocks of the volume, as will be elaborated on in detail below.

In operation 504, a sequentiality factor is calculated for each of the sequential I/O workloads. The sequentiality factor is useful for such things as enabling preferred read ahead of sequential I/O streams which are reading more sequential blocks during a timeframe than other streams. The calculation and use of the sequentiality factor is elaborated upon in detail below.

Detection of Sequential I/O Workload Streams

Various aspects of the present invention operate in environments where multiple I/O workloads run independently of one another, but where I/Os are introduced to the same storage volume in a storage system. Examples of such environments include one or more of:
Multiple workloads running within a single server (e.g., bare metal or virtualized),
Multiple workloads running in respective VMs, each VM having its virtual volume placed on the same physical volume as the other VMs, and
Containers, where sequential I/O workloads are each running in a unique container having a persistent volume claim on the same filesystem located on one physical volume.

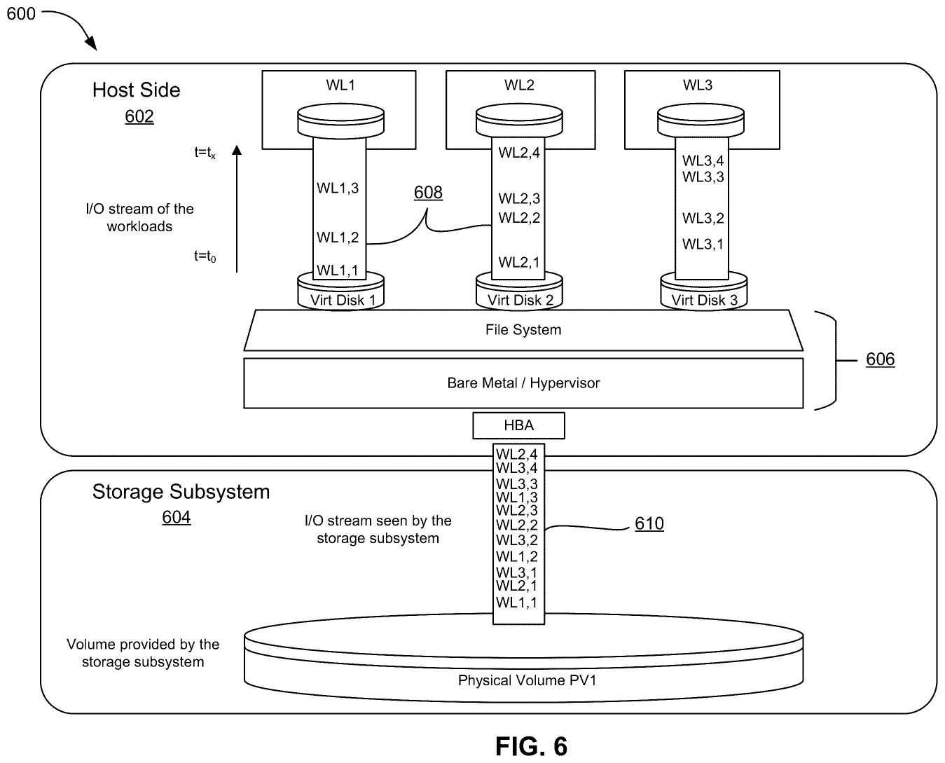

Referring to FIG. 6, which is a diagram of a system 600 having a storage subsystem 604 being accessed by a host side 602. The host side 602 may have any number of workloads, referred to as WLx where {x=1, 2, . . . n}. The workloads may originate from an application, a VM, a container, etc. Moreover, the application, VM, container, etc. may send requests to a virtual disk Virt Diskx where {x=1, 2, . . . n}, which may be part of a File System of known type. The host side 602 may also include any type of interface 606 to the storage subsystem 604, in this example Bare Metal and/or a Hypervisor, as well as a host bus adapter HBA.

For purposes of this illustration, there are depicted three independent workloads WL1, WL2, WL3 which are accessing the same physical volume PV1. The individual I/O stream 608 of the workloads are described as WLx,y, where {x=1,2,3} is related to the workload and {y=1, 2, . . . ,m} represents the number of I/O after a start point, e.g., time=t0. The resulting I/O queue on the HBA will then have a mix of I/Os coming from all three workloads.

For sequential workloads, which retrieve sequential data blocks from the physical volume PV1, the I/O stream 610 presented to the storage subsystem 604 loses its sequential property and the storage system will see a pseudo random I/O stream 610. Thus, the storage subsystem 604 is not able to discern which streams are sequential, making prefetch of data impractical.

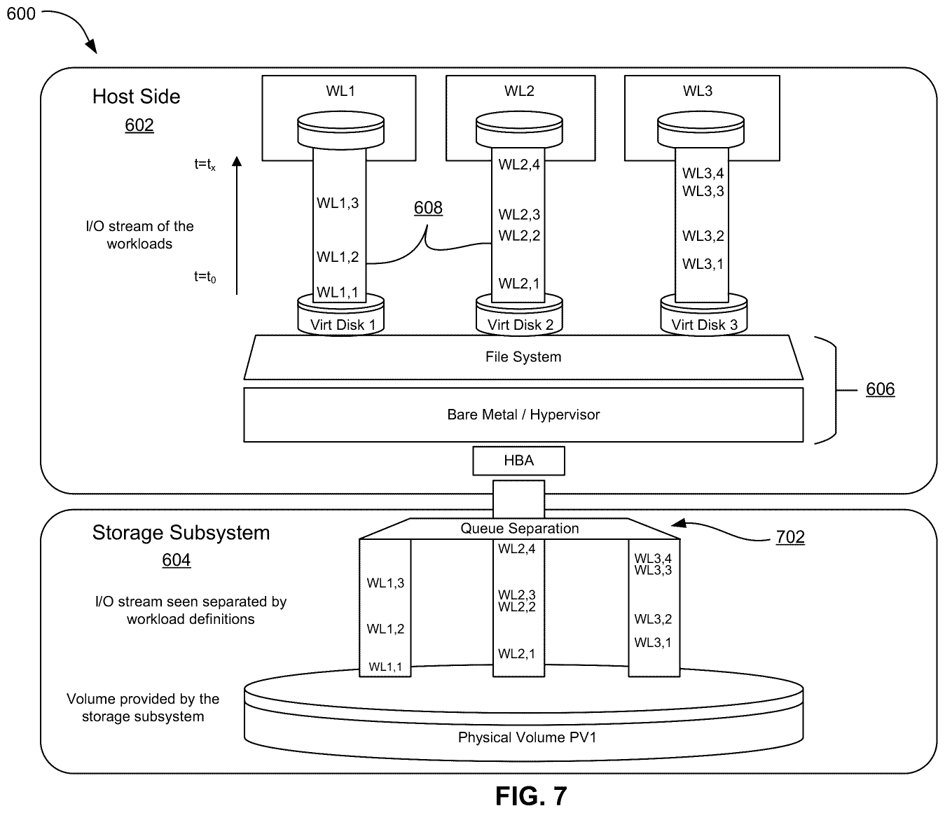

Various aspects of the present invention overcome this drawback by identifying the individual sequential I/O workload streams, thereby allowing such streams to essentially be treated as individual queues within the storage subsystem. Referring to FIG. 7, there is shown the system 600 of FIG. 6, with the new and novel sequential I/O workload detection feature 700 described herein and labeled as Queue Separation in FIG. 7.

“Sequential” I/Os are those that access sequential blocks in a volume. Typically, a physical volume has many blocks of a fixed size, and the blocks are numbered sequentially, e.g., consecutively from 1 to n, where n is the number of blocks in the volume. Normal read ahead algorithms check whether a predefined number of consecutive I/Os access sequential blocks. If this is detected, the read-ahead algorithm causes reading of additional blocks into the cache to be prepared for new incoming I/Os which could request these additional blocks.

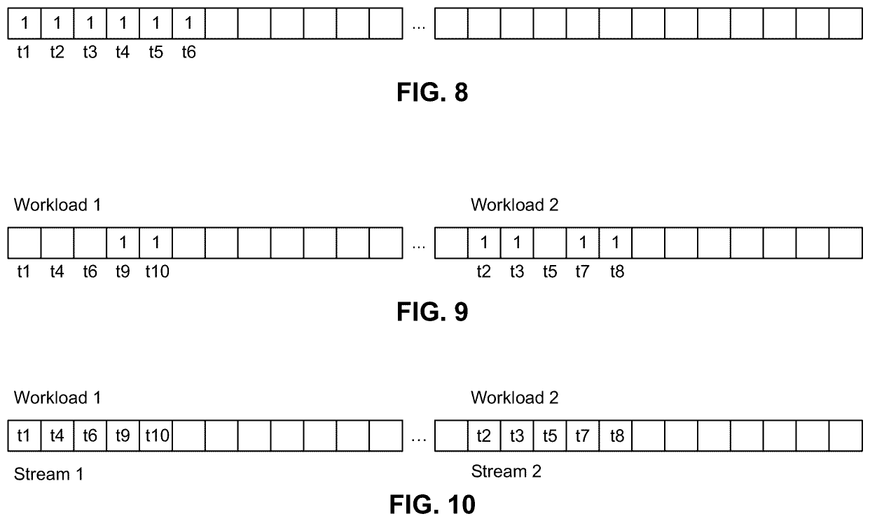

Using a table, such as a bitmap, in which the last I/Os are stored, a sequential I/O can be readily identified. FIG. 8 depicts a bitmap of a portion of a volume, where each field (square) in the bitmap corresponds to a data block in the volume and a “1” in the field represents a consecutive I/O of at least two adjacent data blocks. If the workload is sequential and there are, for example, six I/Os (t1, . . . ,t6) requesting data blocks in a sequential way, the read-ahead algorithm easily can find the sequential I/O by looking at the bitmap. However, in conventional read-ahead algorithms, the bitmap is cleared as soon as one I/O is not addressing a block which would be predicted by the read-ahead algorithm.

Moreover, as soon as there are two sequential workloads superimposed addressing the same volume (e.g., as in FIG. 6), the temporal sequence of the I/O stream is hidden, rendering conventional read-ahead algorithms unable to accurately predict read ahead. The bitmap shown in FIG. 9 depicts an example for the time t10, after ten I/O cycles. Only the bits in the bitmap for the last two I/Os would be recognized as sequential I/O. The blocks accessed at t4 and t6 would not be recognized by conventional read-ahead algorithms as corresponding to sequential I/O because I/O was performed at a different location in the volume at t2, t3 and t5.

The methodology, according to one embodiment, is not to simply refer to the last entry in the table (e.g., bitmap) to detect sequential workloads, but to define a relationship where a temporal dependency is defined to detect the sequential access. The time dependency can be in real time, based on I/O count (e.g., by counting every I/O) in a table or map of accessed blocks, etc. The methodology to separate the individual workloads and their corresponding I/O streams, according to one embodiment, not only leverages the location of each of the reads within the volume, but also the temporal characteristics of the reads.

FIG. 10 depicts a table (bitmap) in which a time dependency of the I/O is also included, thereby allowing a time dependency to be derived from a table of accessed blocks. Instead of simply registering an I/O in the bitmap, the individual time such as a timestamp corresponding to the I/O (or equivalently the number of I/O to this individual volume) is reflected (e.g., stored) in the bitmap. The inventive algorithm to detect sequential I/O is then able to take into account when the block prior to the now-accessed block has been accessed. In this way, the sequentially can be determined by using a decay function which is time and/or I/O dependent.

In the example shown in FIG. 10, consider the first area of accessed blocks, which are accessed at times t1, t4, t6, t9 and t10. The inventive algorithm allows a predefined quantity of I/Os (for example, two, three, four, or more) going into other areas of the volume between I/Os to the area of interest in the volume, the I/Os to that area of interest are still considered a sequential stream, and thus, the access is defined as sequential.

Using the knowledge, an inference is made that a sequential I/O stream is requesting blocks from the target area of the volume, and additional blocks in the target area can be read into cache. This read ahead can be performed for each of the sequential I/O workloads, thereby greatly improving performance in terms of speed of serving data from the storage system. For example, looking at FIG. 10, one or more blocks following the blocks read at t10 and t8 can be loaded into the read ahead cache, so that they are ready to be served to Workload 1 and Workload 2, respectively, from cache if requested. Moreover may allow the storage system to utilize otherwise unused CPU cycles.

Thus, in preferred embodiments, the individual sequential I/O workloads are detected by analyzing accesses to sequential blocks in the volume during a period of time and/or across a number of accesses to the volume. The period of time and/or number of accesses may be predefined, selected based on historical data, based on a sliding window, based on a current workflow, etc. The individual sequential I/O workloads can thus be detected even when temporally consecutive accesses to the volume access nonsequential blocks, e.g., as shown in FIG. 10. In some cases, individual sequential I/O workloads are detected even though no two consecutive I/Os access sequential blocks.

Sequentiality Factor

Because the individual sequential I/O workloads are identifiable, a sequentiality factor can be calculated for each of the sequential I/O workloads. The sequentiality factor can be any number, ratio, data, function, etc. that reflects a temporal-based indication of sequential accesses for a given sequential I/O workload.

The sequentiality factor is useful for many purposes. For example, the sequentiality factors for several sequential I/O workloads may be compared and used to give read ahead preference for blocks expected to be requested by one or more of the sequential I/O workloads.

The sequentiality factors can be calculated using any technique that would become apparent to one skilled in the art upon being apprised of the present disclosure.

In one embodiment, the sequentiality factor for each sequential I/O workload is calculated based on a formula having as variables the number of I/Os in a sequential stream of the sequential I/O workload and a total number of I/Os against the volume by all streams during performance of said number of I/Os. For example, the formula may include the number of I/Os in the sequential stream of the sequential I/O workload divided by the aforementioned total number of I/Os.

In an exemplary approach, a sequentiality factor, Sstreamx, is calculated for each stream x, where:

Sstreamx=Number of I/Os in a sequential stream x/Number of I/Os against the volume.

Looking to the example of FIG. 10, Streams 1 and 2 have the following sequentiality factor:

Sstream1= 5/10=0.5(5sequential reads in 10 read cycles t1-t10)

Sstream2= 5/7=0.71(5sequential reads in 7 read cycles t2-t8)

By comparing the sequentiality factors for Streams 1 and 2, the storage system may favor the read ahead of Stream 2 over the read ahead of Stream 1, thereby optimizing management and use of the limited read ahead cache. Thus, for example, a preferred order of read ahead of blocks of the volume for one or more of the sequential I/O workloads may be determined based on the sequentiality factors, and such read ahead of blocks for one or more of the sequential I/O workloads according to the preferred order may be performed. Any technique for determining a preferred order of read ahead may be used. For example, read ahead for the workload having the highest ranked sequentiality factor may be performed first, then read ahead performed for the workload having the second highest ranked sequentiality factor, and so on. Other techniques that would become apparent to one skilled in the art upon reading the present disclosure may be used. Using such a read-ahead algorithm, a storage system can improve the latency for I/O requests, and may also leverage unused CPU cycles.

Moreover, the sequentiality factor can be analyzed to gain a better understanding of the workloads, which in turn can be used to adjust allocations of storage resources such as CPU and memory.

General Computer Environment

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
detecting individual sequential input/output (I/O) workloads in a stream of superimposed I/O workloads accessing a same physical volume,
the detecting being based on a time dependency corresponding to accesses of blocks of the volume.

2. The computer-implemented method of claim 1, wherein the individual sequential I/O workloads are detected by analyzing accesses to sequential blocks in the volume during a period of time and/or across a number of accesses to the volume.

3. The computer-implemented method of claim 2, wherein the individual sequential I/O workloads are detected even when temporally consecutive accesses to the volume access nonsequential blocks.

4. The computer-implemented method of claim 1, wherein the time dependency is derived from a table of accessed blocks.

5. The computer-implemented method of claim 1, comprising calculating a sequentiality factor for each of the sequential I/O workloads.

6. The computer-implemented method of claim 5, wherein the sequentiality factor for each sequential I/O workload is calculated based on a formula that includes as variables: a number of I/Os in a sequential stream of the sequential I/O workload and a total number of I/Os against the volume during performance of said number of I/Os.

7. The computer-implemented method of claim 5, comprising determining a preferred order of read ahead of blocks for one or more of the sequential I/O workloads based on the sequentiality factors.

8. The computer-implemented method of claim 7, comprising performing read ahead of blocks for one or more of the sequential I/O workloads according to the preferred order.

9. The computer-implemented method of claim 1, wherein the method is performed by a storage system having the volume.

10. A computer-implemented method, comprising:
detecting a plurality of sequential input/output (I/O) workloads in an I/O stream of superimposed workloads accessing a same volume, the detecting being based on a time dependency corresponding to accesses of blocks of the volume; and
calculating a sequentiality factor for each of the sequential I/O workloads.

11. The computer-implemented method of claim 10, wherein the time dependency is derived from a table of accessed blocks.

12. The computer-implemented method of claim 10, wherein the individual sequential I/O workloads are detected by analyzing accesses to sequential blocks in the volume during a period of time and/or across a number of accesses to the volume.

13. The computer-implemented method of claim 10, wherein the sequentiality factor for each sequential I/O workload is calculated based on a formula that includes as variables: a number of I/Os in a sequential stream of the sequential I/O workload and a total number of I/Os against the volume during performance of said number of I/Os.

14. The computer-implemented method of claim 10, comprising determining a preferred order of read ahead of blocks for one or more of the sequential I/O workloads based on the sequentiality factors.

15. The computer-implemented method of claim 14, comprising performing read ahead of blocks for one or more of the sequential I/O workloads according to the preferred order.

16. The computer-implemented method of claim 10, wherein the method is performed by a storage system having the volume.

17. A computer program product, the computer program product comprising a computer readable storage medium having program instructions embodied therewith, the program instructions executable by a processor to cause the processor to:
detect, by the processor, individual sequential input/output (I/O) workloads in a stream of superimposed I/O workloads accessing a same physical volume,
the detecting being based on a time dependency corresponding to accesses of blocks of the volume.

18. The computer program product of claim 17, wherein the individual sequential I/O workloads are detected by analyzing accesses to sequential blocks in the volume during a period of time and/or across a number of accesses to the volume.

19. The computer program product of claim 17, comprising program instructions executable by a processor to cause the processor to calculate a sequentiality factor for each of the sequential I/O workloads.

20. The computer program product of claim 19, comprising program instructions executable by a processor to cause the processor to determine a preferred order of read ahead of blocks for one or more of the sequential I/O workloads based on the sequentiality factors.
